(19) United States
(12) Patent Application Publication
(10) Pub. No.: US 2016/0190748 A1
(43) Pub. Date: Jun. 30, 2016

(54) Power Strip with External Networking Accessory Devices

(71) Applicant: TrickleStar Ltd., Central (HK)

(72) Inventor: Bernard Christopher Emby, Kuala Lumpur (MY)

(21) Appl. No.: 14/812,408

(22) Filed: Jul. 29, 2015

Related U.S. Application Data
(60) Provisional application No. 62/049,019, filed on Sep. 11, 2014.

(51) Int. Cl. H01R 13/66; G08B 21/18; H01R 25/00

(52) U.S. Cl. CPC H01R 13/6691; H01R 25/003; G08B 21/182

(57) ABSTRACT

A load controlling device includes a housing having at least one outlet and at least one low voltage interface; and an external accessory operatively connected to the at least one low voltage interface and comprising a controller and communications circuitry operatively connected to the controller. The external accessory is powered by the low voltage interface and is configured to monitor the at least one outlet and transmit information to an external device regarding the at least one outlet via the communications circuitry.

### CROSS REFERENCE TO RELATED APPLICATION

This application claims the benefit of U.S. Provisional Patent Application No. 62/049,019, filed Sep. 11, 2014, the disclosure of which is incorporated by reference in its entirety.

### BACKGROUND OF THE INVENTION

1. Field of the Invention

The present invention relates generally to load controlling devices, such as power strips and single outlet load controllers, and, more particularly, to load controlling devices configured to be operatively connected to external networking accessory devices.

2. Description of Related Art

One type of electrical extension cord, commonly known as a power strip, generally includes an elongated box-like housing having a row of plug-receiving receptacles formed therein, an on/off switch, and a single power cord which is connectable to a standard AC nominal 110 volt (foreign 220 volts) wall or other outlet. The power cord is typically plugged into the power outlet to energize the power strip. Thereafter, a plurality of devices may be plugged into the various plug receiving receptacles of the power strip. When the on/off switch of the power strip is turned to its “ON” position, current will flow to the plug-receiving receptacles and any devices which are plugged into the receptacles will become energized. Conversely, when the on/off switch is placed in its “OFF” position, devices which are plugged into the electrical power strip will become de-energized. Some of the currently available electrical power strips include resettable circuit breakers and generally include circuitry involving power surge suppression and noise filtration to protect the personal computer from power surges, noise that comes from standard AC power, and power outages or blackouts. Some power controllers also include a backup power supply in the form of a battery that can sustain the computer if a power outage or blackout occurs. These conventional power controller devices function to transmit power to a computer and peripheral devices, but generally fail to control any operative functions of the computer or its peripheral devices.

In addition, these conventional power strips do not reduce or eliminate vampire power unless the power strip is switched to the “OFF” position. Also known as standby power, leaking electricity, or phantom load, vampire power is wasted electrical energy consumed while certain appliances are switched off but still plugged in. These appliances range from televisions, home entertainment systems, personal computers and peripherals, to space heaters, room air-conditioners, and coffee pots. All of these appliances continue to draw power even when they are turned off. Averaging 10-15 watts per hour per device, vampire power is a constant drain on a person's wallet as well as the electrical grid.

Accordingly, advanced power strips have been developed to address the problem of vampire power. These advanced power strips include a master outlet and/or a USB input and a plurality of slave outlets. A personal computer or television is connected to the master outlet and/or the USB input and peripheral devices related to the personal computer or television are connected to the slave outlets. When the personal computer or television is turned on, the peripheral devices connected to the slave outlets are switched on and vice versa when the personal computer or television is turned off. Accordingly, the switching is performed automatically.

However, such a system prevents the use of the peripheral devices unless the personal computer or television is turned on. For instance, in a home theater installation, there are a range of components, such as an AV receiver, DVD player, speakers, etc., which may be used while watching television. However, many of these components may also be used, such as to play music, when the television is turned off. Accordingly, if a person wants to listen to music, he/she needs to switch on the television so that the AV receiver, DVD player, and speakers, which are connected to the slave outlets, can be provided with power. In this scenario, it is not desirable to switch on the television in order to listen to music. This is a severe limitation of advanced power strips and in many cases will prevent a person from installing an advanced power strip.

In addition, such advanced power strips, as well as conventional power strips and single outlet load controllers, typically include networking capabilities via a variety of platforms including, but not limited to, Bluetooth, Wi-Fi, ModBus, wired Ethernet, RS232, RS485, Z-Wave, ZigBee, Wavenis, Enocean, and proprietary RF technologies. Due to the large number of networking platforms available, challenges arise as to which platforms to support and incorporate into the power strip. This results in multiple power strip products for each networking platform, sometimes with multiple variations depending on market voltages and plug standards.

Each of these products requires separate electrical safety and RF approvals. The safety approval and RF approval processes are time consuming and costly. When multiplied across multiple products, the commercial costs and complexities for a vendor to support multiple networking technologies can be prohibitive. Adding other considerations such as to time to market, technology obsolescence, and inventory holding costs further complicate the technology selection. As a result, power strip manufacturers tend to select a single or a very limited range of technology platforms that they elect to deploy in their products.

Accordingly, a need exists for a load controlling device that is capable of supporting a variety of networking platforms via an external networking device.

### SUMMARY OF THE INVENTION

An object of the invention is to provide a load controlling device, such as a power strip or a single outlet load controller, that is capable of supporting a variety of networking platforms via an external networking device. Such a load controlling device requires only one electrical safety approval for the load controlling device, and each external accessory device could work with each of these products. In this way, a manufacturer can produce a single load controlling device product and then produce multiple external accessory devices to support multiple networking technologies.

In accordance with one aspect of the invention, provided is a load controlling device including a housing having at least one outlet and at least one low voltage interface; and an external accessory operatively connected to the at least one low voltage interface and including a controller and communications circuitry operatively connected to the controller. The external accessory is powered by the low voltage interface and is configured to monitor the at least one outlet and transmit information to an external device regarding the at least one outlet via the communications circuitry.

The load controlling device may be a power strip having multiple outlets. At least one of the outlets may be a master outlet and the other outlets are switched outlets. At least one of the outlets may be a master outlet and the other outlets are slave outlets. The power strip may include a masterless configuration, such that the outlets are individually switchable. Alternatively, the load controlling device may be a single outlet load controller.

The external accessory may be at least one of or a combination of a timer switch, a dongle, a motion sensor, a light level sensor, and a foot switch. The information transmitted by the external accessory may be at least one of or a combination of voltage and frequency, status of the at least one outlet, power consumption in real time, and historical power consumption. The external accessory may be configured to receive commands from the external device. The load controlling device may be configured with a power threshold sensing capability so as to trigger a signal or alarm in an event a consumption level of the power strip exceeds a predetermined threshold. The external device may be at least one of a smartphone, a personal computer, a tablet computer, a router, a security panel, and a software portal. The communications circuitry may be configured to support at least one communication protocol selected from the group including Bluetooth, Wi-Fi, ModBus, wired Ethernet, RS232, RS485, Z-Wave, ZigBee, Wavenis, and Enocean.

In accordance with another aspect of the invention, provided is a power strip that includes: a housing; at least one outlet provided on the housing; and a low voltage interface provided on the housing. The low voltage interface is configured to be operatively connected to an external accessory having communication circuitry such that information regarding the at least one outlet is transmitted to an external device via the communications circuitry.

In accordance with yet another aspect of the invention, provided is a power management system that includes at least one load controlling device and an external accessory. The load controlling device, such as a power strip or a single outlet load controller includes a housing having at least one outlet and at least one low voltage interface. The external accessory is operatively connected to the at least one low voltage interface of the load controlling device and includes a controller and communications circuitry operatively connected to the controller. The external accessory is powered by the low voltage interface and is configured to monitor the at least one outlet and transmit information to an external device regarding the at least one outlet via the communications circuitry. The power strip may include a masterless configuration. The power strip may include a master and slave configuration.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a top plan view of a load controlling device, embodied as a power strip, operatively connected to an external accessory having networking capabilities in accordance with the present invention;

FIG. 2 is a top plan view of the load controlling device of FIG. 1 where the external accessory is embodied as a Bluetooth footswitch capable of communicating with a personal computer or smartphone;

FIG. 3 is a top plan view of various embodiments of a load controlling device including a one outlet load controller, a four outlet power strip, and nine outlet power strip illustrated as being operatively connected to an external accessory such as a foot switch; and

FIG. 4 is a top plan view of an exemplary load controlling device being connected to a variety of different external accessories.

### DESCRIPTION OF THE INVENTION

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

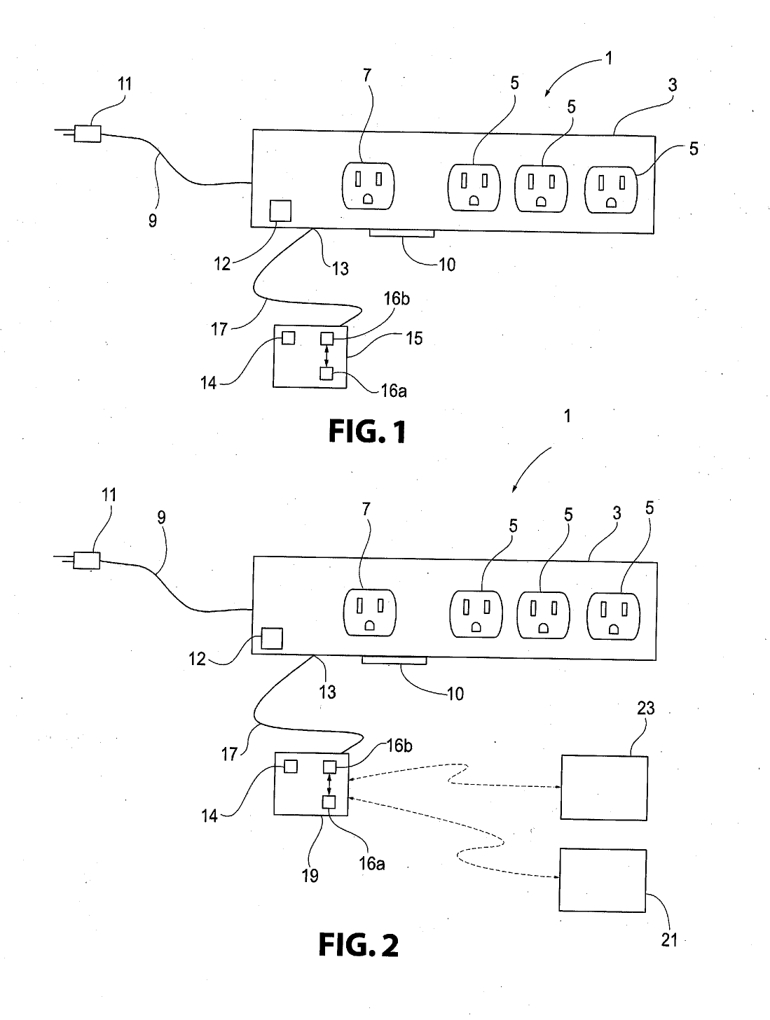

With reference to FIG. 1, a load controlling device such as a four outlet power strip, denoted generally as reference numeral 1, includes a housing 3. The housing 3 is desirably manufactured from a plastic material that is UV stable. Housing 3 may also include a plurality of mounting holes (not shown) on a bottom portion thereof for mounting advanced power strip 1 to a surface, such as a floor or wall. Housing 3 may be substantially rectangular. Housing 3 further includes multiple outlets including a plurality of switched outlets 5 and at least one master outlet or also referred to as an always-on outlet 7, a resetable circuit breaker with integrated on/off switch 10, and a mains power cord 9 ending in a male mains voltage plug 11 that is configured to be coupled to a female mains voltage receptacle (not shown). This embodiment of the power strip 1 includes one master outlet 7 and three switched outlets 5. It is to be understood, however, that any number of switched outlets 5 and master outlets 7 may be provided on the power strip 1 according to the desired number of devices to be connected to the power strip 1. In one aspect, at least one of the outlets may be a master outlet and the other outlets may be switched outlets.

In a preferred embodiment, the power strip includes a master and slave configuration, wherein at least one of the outlets is a master outlet and other outlets are slave outlets. In another preferred embodiment, the power strip includes a masterless configuration such that the outlets are individually switchable. Also, in another preferred embodiment, the load controlling device is configured as a single outlet load controller, such that the load controlling device is provided in a masterless configuration.

The plurality of switched outlets 5 may be switched on a single relay (now shown). The relay is desirably a mechanically latching relay that is rated for a minimum of 100,000 operations at full load. In addition, the relay should be configured to operate with minimum noise such that it is not audible from a distance of more than 2 meters. The always-on outlet 7 remains on at all times as long as the on/off switch 10 is in the on position.

The power strip 1 also includes one or more low voltage interfaces 13. The low voltage interface 13 may be embodied as an RJ11 female connector or an RJ45 connector (not shown). The low voltage interface 13 supports bi-directional communication to and provides power for an external accessory 15 through a low voltage cable 17. One end of the low voltage cable 17 may be operatively connected to the low voltage interface 13 and an opposing end of the low voltage cable 17 may be operatively connected to the external accessory 15. The external accessory 15 includes a controller 16a and communications circuitry 16b operatively connected to the controller 16a. The controller 16a of the external accessory is configured to monitor the power strip 1 and transmit information to an external device regarding the power strip 1 via the communications circuitry 16b. The communications circuitry 16b may be configured to support at least one communication protocol.

With reference to FIG. 2 and with continued reference to FIG. 1, the external accessory 15 may be any number of devices such as, but not limited to, a dongle, a desktop switch, a foot switch, a motion sensor, and a light level sensor. FIG. 2 illustrates the external accessory as a foot switch 19 having a Bluetooth communication protocol incorporated therein.

The Bluetooth communication protocol of the foot switch 19 allows the foot switch 19 to communicate information regarding the power strip 1 to an external device, such as a smart phone 21 or personal computer 23. Information that may be transmitted by the foot switch 19 or any other external accessory 15 includes, but is not limited to, voltage and frequency, status of outlets (i.e., on/off), power consumption in real time, and historical power consumption. In addition, the foot switch 19 or any other external accessory 15 connected to the low voltage interface 13 may also receive commands from the smartphone 21 and/or the personal computer 23. For example, the smartphone 21 may be configured to transmit an on-off command to the foot switch 19 which would then control the power strip 1. The transmitted information may be displayed on a screen of the external device. A signal or alarm may also be activated by the external device based on the occurrence of predetermined conditions of the power strip 1, such as a maximum voltage or power consumption being achieved by the power strip 1. It should be appreciated by a person skilled in the art that in this context, the maximum voltage or power consumption which are the predetermined conditions of the power strip, are parameters for achieving auto power threshold sensing capability, such that a signal or alarm is triggered in the event of a consumption level of the power strip exceeding a predetermined threshold, which is independent of human intervention.

The power strip 1 communicates with the external accessory 15 via a wired bi-directional serial communications interface. A universal asynchronous receiver/transmitter (UART) 12, 14 is provided in both the power strip 1 and the external accessory 15. These UARTs communicate with each other to transmit information between the power strip 1 and the external accessory 15. The power strip 1 and the external accessory 15 may communicate using the low voltage cable 17. This transmitted information may include, but is not limited to, voltage and frequency, status of outlets (i.e., on/off), power consumption in real time, and historical power consumption. The external accessory 15 further includes communications circuitry 16b to transmit this information to an external device as discussed hereinabove. Using the communication system between the power strip 1 and the external accessory 15, and the external accessory 15 and the external device, information regarding the power strip 1 is easily and efficiently transmitted to the external device to notify an individual of the operating status of the power strip 1. Based on this information, the individual may take action on the power strip 1 based on the voltage and frequency of the power strip 1, the status of outlets (i.e., on/off) of the power strip 1, and/or power consumption of the power strip 1 in real time.

The external device was discussed hereinabove as being a smartphone 21 or personal computer 23. This is not to be construed as limiting the present disclosure as the external accessory 15 may also be configured to communicate with any number of suitable external devices. These external devices can be placed in three general categories of communication as follows: 1) smart devices such as personal computers, smartphones, and tablet computers to the external accessory 15 (these devices can be on a local network or they may be on a remote network); 2) controller to the external accessory 15 (the controller may be a router, security panel, software portal, or set top box with intelligence to communicate to the external accessory 15 and, thus, control or draw data from the load controlling device); and 3) sensor to load controlling device (such as a motion sensor, this would be most typical with a technology such as ZigBee or Z-Wave).

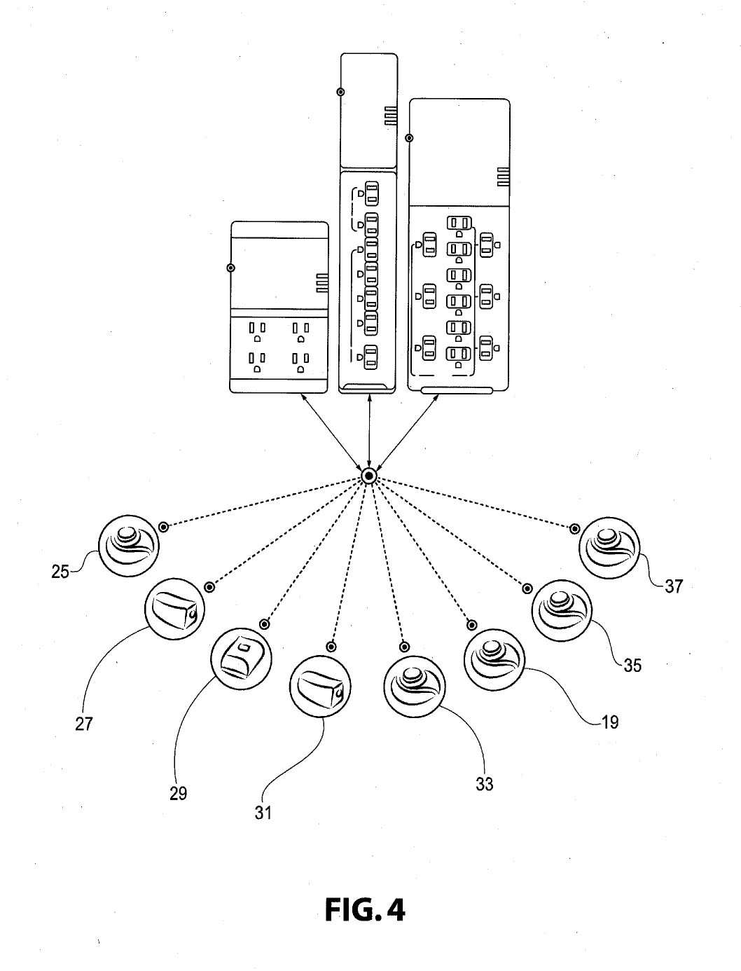

In addition, the external accessory 15 was discussed hereinabove as being a Bluetooth foot switch 19. This is also not to be construed as limiting the present disclosure as any number of external accessories may be utilized. With reference to FIG. 4, exemplary external accessories may be a timer switch 25, a motion sensor 27, a light level sensor 29, and a multi-sensor 31. Furthermore, while the foot switch 19 was described hereinabove as having Bluetooth communication capabilities, other communication capabilities may be incorporated into the foot switch to provide a Wi-Fi foot switch 33, a Z-wave foot switch 35, or a Zigbee foot switch 37, for example.

Further, the aforementioned communications circuitry 16b is configured to support at least one communication protocol such as, but not limited to, Bluetooth, Wi-Fi, ModBus, wired Ethernet, RS232, RS485, Z-Wave, ZigBee, Wavenis, Enocean, and proprietary RF technologies. It is also contemplated that more than one communication protocol may be supported by the communications circuitry 16b.

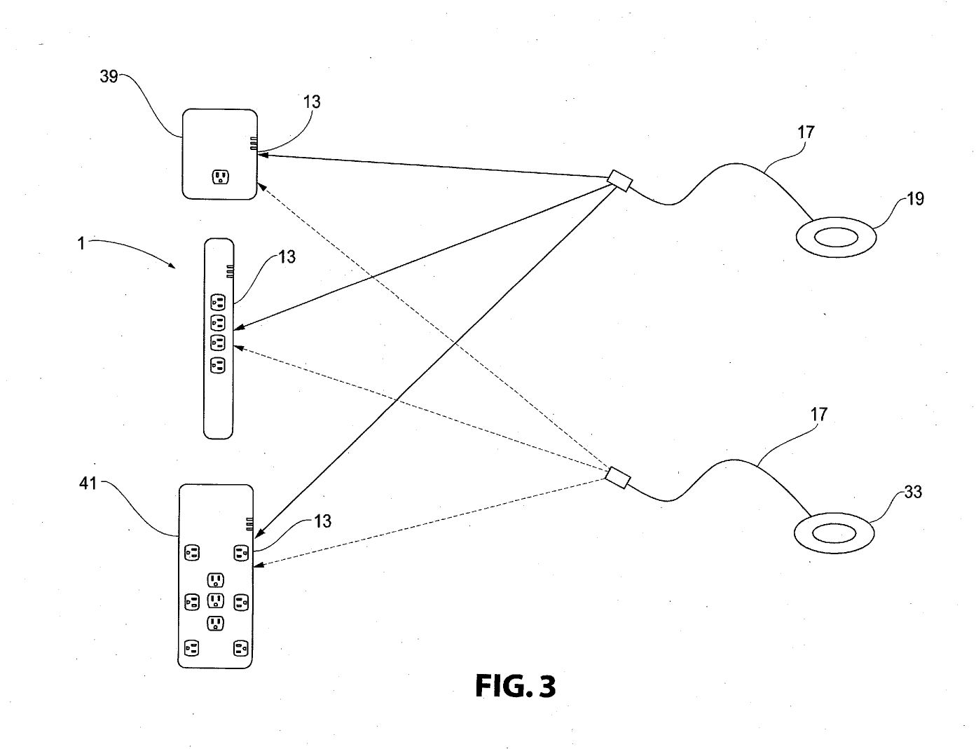

With reference to FIG. 3, while the load controlling device was discussed hereinabove as being a four outlet power strip, this is not to be construed as limiting the present invention, as the load controlling device may also be configured as a single outlet load controller 39 having a low voltage interface 13 or a nine outlet power strip 41 having a low voltage interface 13. By providing the communications circuitry 16b in an external accessory rather than in the load controlling device, a single external device, such as the Bluetooth foot switch 19 described above, can be configured to provide networking capabilities to the four outlet power strip 1, the single outlet load controller 39, and/or the nine outlet power strip 41. It is also contemplated that the Bluetooth foot switch 19 can be configured to provide networking capabilities to each of the four outlet power strip 1, the single outlet load controller 39, and the nine outlet power strip 41. As shown in FIG. 4, the Bluetooth foot switch 19 may be connected to the power strip 1 via a low voltage cable 17. Using this integrated network with the Bluetooth foot switch 1, an individual can control the status of each component using an external device, such as the smartphone 21 or personal computer 23. If a vendor then decided to add Wi-Fi support, a Wi-Fi foot switch 33 could be produced and offered with the four outlet power strip 1, the single outlet load controller 39, and/or the nine outlet power strip 41.

This approach, thus, requires only one electrical safety approval for the load controlling devices, and each external accessory 15 could work with each of these load controlling devices. In this way, a manufacturer can produce a single load controlling device product and then produce multiple external accessories to support multiple networking technologies.

Although the invention has been described in detail, for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements. For example, it is to be understood that the present invention contemplates that, to the extent possible, one or more features of any embodiment can be combined with one or more features of any other embodiment.

The invention claimed is:

1. A load controlling device comprising:
a housing comprising at least one outlet and at least one low voltage interface; and
an external accessory operatively connected to the at least one low voltage interface and comprising a controller and communications circuitry operatively connected to the controller,
wherein the external accessory is powered by the low voltage interface and is configured to monitor the at least one outlet and transmit information to an external device regarding the at least one outlet via the communications circuitry.

2. The load controlling device of claim 1, wherein the load controlling device is a power strip having multiple outlets.

3. The load controlling device of claim 2, wherein at least one of the outlets is a master outlet and the other outlets are switched outlets.

4. The load controlling device of claim 2, wherein at least one of the outlets is a master outlet and the other outlets are slave outlets.

5. The load controlling device of claim 2, wherein the power strip comprises a masterless configuration such that the outlets are individually switchable.

6. The load controlling device of claim 1, wherein the load controlling device is a single outlet load controller.

7. The load controlling device of claim 1, wherein the external accessory is at least one or a combination of a timer switch, a dongle, a motion sensor, a light level sensor, and a foot switch.

8. The load controlling device of claim 1, wherein the information transmitted by the external accessory is at least one or a combination of voltage and frequency, status of the at least one outlet, power consumption in real time, and historical power consumption.

9. The load controlling device of claim 1, wherein the external accessory is configured to receive commands from the external device.

10. The load controlling device of claim 1, wherein the load controlling device is configured with a power threshold sensing capability so as to trigger a signal or alarm in an event a consumption level of the power strip exceeds a predetermined threshold.

11. The load controlling device of claim 1, wherein the external device is at least one or a combination of a smartphone, a personal computer, a tablet computer, a router, a security panel, and a software portal.

12. The load controlling device of claim 1, wherein the communications circuitry is configured to support at least one communication protocol.

13. The load controlling device of claim 12, wherein said at least one communication protocol is selected from the group comprising Bluetooth, Wi-Fi, ModBus, wired Ethernet, RS232, RS485, Z-Wave, ZigBee, Wavenis, and Enocean.

14. A power strip comprising:
a housing;
at least one outlet provided on the housing; and
a low voltage interface provided on the housing,
wherein the low voltage interface is configured to be operatively connected to an external accessory having communications circuitry such that information regarding the at least one outlet is transmitted to an external device via the communications circuitry.

15. The power strip of claim 14, wherein a plurality of outlets are provided on the housing.

16. The power strip of claim 15, wherein at least one of the outlets is a master outlet and the other outlets are switched outlets.

17. The power strip of claim 15, wherein at least one of the outlets is a master outlet and the other outlets are slave outlets.

18. The power strip of claim 15, wherein the power strip comprises a masterless configuration such that the outlets are individually switchable.

19. The power strip of claim 14, wherein the external accessory is at least one or a combination of a timer switch, a dongle, a motion sensor, a light level sensor, and a foot switch.

20. The power strip of claim 14, wherein the information transmitted by the external accessory is at least one or a combination of voltage and frequency, status of the at least one outlet, power consumption in real time, and historical power consumption.

21. The power strip of claim 14, wherein the external accessory is configured to receive commands from the external device.

22. The power strip of claim 14, wherein the external device is at least one of or a combination of a smartphone, a personal computer, a tablet computer, a router, a security panel, and a software portal.

23. The power strip of claim 14, wherein the load controlling device is configured with a power threshold sensing capability so as to trigger a signal or alarm in an event a consumption level of the power strip exceeds a predetermined threshold.

24. The power strip of claim 14, wherein the communications circuitry is configured to support at least one communication protocol.

25. The power strip of claim 24, wherein said at least one communication protocol is selected from the group comprising Bluetooth, Wi-Fi, ModBus, wired Ethernet, RS232, RS485, Z-Wave, ZigBee, Wavenis, and Enocean.

26. A power management system comprising:
at least one load controlling device comprising:
a housing comprising at least one outlet and at least one low voltage interface; and
an external accessory operatively connected to the at least one low voltage interface of the load controlling device and comprising a controller and communications circuitry operatively connected to the controller,
wherein the external accessory is powered by the low voltage interface and is configured to monitor the at least one outlet and transmit information to an external device regarding the at least one outlet via the communications circuitry.

27. The power management system of claim 26, wherein the at least one load controlling device comprises a power strip having multiple outlets.

28. The power management system of claim 26, wherein the at least one load controlling device comprises at least one of a single outlet load controller and a power strip having multiple outlets.

29. The power management system of claim 27, wherein the power strip comprises a masterless configuration.

30. The power management system of claim 27, wherein the power strip comprises a master and slave configuration.
